(19) United States
(12) Patent Application Publication
(10) Pub. No.: US 2025/0373767 A1
(43) Pub. Date: Dec. 4, 2025

(54) CORRECTION METHOD

(71) Applicant: SEIKO EPSON CORPORATION, Tokyo (JP)

(72) Inventor: Yutaro IIJIMA, Matsumoto-shi (JP)

(73) Assignee: SEIKO EPSON CORPORATION, Tokyo (JP)

(21) Appl. No.: 19/222,285

(22) Filed: May 29, 2025

(30) Foreign Application Priority Data
May 30, 2024 (JP) 2024-087939

(51) Int. Cl. H04N 9/31

(52) U.S. Cl. CPC H04N 9/3185; H04N 9/3194

(57) ABSTRACT

A method for correcting a projection image projected from a projector onto a projection surface, the method including: acquiring depth information indicating multiple distances from a distance sensor to multiple positions on the projection surface based on an output from the distance sensor; calculating a position of a plane based on the depth information; calculating a first normal vector for the plane; calculating a gravity vector based on an output from an acceleration sensor associated with a coordinate system of the projector; generating a second normal vector by converting the first normal vector in such a way that an inner product of the gravity vector and the first normal vector is a cosine of an angle between a horizontal plane and the projection surface; and correcting the projection image based on the second normal vector.

The present application is based on, and claims priority from JP Application Serial Number 2024-087939, filed May 30, 2024, the disclosure of which is hereby incorporated by reference herein in its entirety.

### BACKGROUND

### 1. Technical Field

The present disclosure relates to a correction method.

### 2. Related Art

There has been a related-art technology for determining the normal vector for a projection surface by using a value measured by a distance sensor provided in a projector, and correcting a projection image by using the determined normal vector.

For example, a projector according to WO 2022/193560 acquires depth information at multiple light spots on a projection surface by using a time-of-flight (ToF) sensor, and determines the normal vector for the projection surface based on the multiple depth information. Furthermore, the projector acquires offset information on the amount of offset of the projector based on the normal vector, and corrects a projection image based on the offset information.

WO 2022/193560 is an example of the related art.

However, since the projector according to WO 2022/193560 uses only the value measured by the distance sensor to correct the projection image, the accuracy of the correction undesirably depends on the accuracy of the distance sensor.

### SUMMARY

A correction method according to a first aspect of the present disclosure is a method for correcting a projection image projected from a projector onto a projection surface, the method including: acquiring depth information indicating multiple distances from a distance sensor to multiple positions on the projection surface based on an output from the distance sensor; calculating a position of a plane based on the depth information; calculating a first normal vector for the plane; calculating a gravity vector based on an output from an acceleration sensor associated with a coordinate system of the projector; generating a second normal vector by converting the first normal vector in such a way that an inner product of the gravity vector and the first normal vector is a cosine of an angle between a horizontal plane and the projection surface; and correcting the projection image based on the second normal vector.

A correction method according to a second aspect of the present disclosure is a method for correcting a projection image projected from a projector onto a projection surface, the method including: acquiring depth information indicating multiple distances from a distance sensor to multiple positions on the projection surface based on an output from the distance sensor; calculating a position of a plane based on the depth information; calculating a first normal vector for the plane; calculating a gravity vector based on an output from an acceleration sensor associated with a coordinate system of the projector; calculating an outer product of the gravity vector and the first normal vector to generate an orthogonal vector orthogonal to both the gravity vector and the first normal vector; generating, as a second normal vector that is a normal vector for the projection surface, a rotation vector as a result of rotation of the gravity vector around an axis along the orthogonal vector by an angle between a horizontal plane and the projection surface; and correcting the projection image based on the second normal vector.

A correction method according to a third aspect of the present disclosure is a method for correcting a projection image projected from a projector onto a projection surface, the method including: acquiring depth information indicating multiple distances from a distance sensor to multiple positions on the projection surface based on an output from the distance sensor; calculating a position of a plane based on the depth information; calculating a first normal vector for the plane; calculating a gravity vector based on an output from an acceleration sensor associated with a coordinate system of the projector; calculating an outer product of the gravity vector and the first normal vector to generate an orthogonal vector orthogonal to both the gravity vector and the first normal vector; calculating an outer product of the orthogonal vector and the gravity vector to generate a second normal vector orthogonal to both the orthogonal vector and the gravity vector; and correcting the projection image based on the second normal vector.

### BRIEF DESCRIPTION OF THE DRAWINGS

FIG. 1 is a block diagram showing an example of the configuration of a projector.

FIG. 2 shows an example of depth information acquired by an acquisition section.

FIG. 3 illustrates an example of a method for calculating an angle between an installation surface at which the projector is installed and a projection surface.

FIG. 4 illustrates the example of the method for calculating the angle between the installation surface at which the projector is installed and the projection surface.

FIG. 5 illustrates an example of the method for calculating the angle between the installation surface at which the projector is installed and the projection surface.

FIG. 6 illustrates an example of the method for calculating the angle between the installation surface at which the projector is installed and the projection surface.

FIG. 7 illustrates a method for generating a second normal vector in a case where the projection surface stands upright in the vertical direction and only one component of a first normal vector is converted.

FIG. 8 illustrates the method for generating the second normal vector in the case where the projection surface stands upright in the vertical direction and only one component of the first normal vector is converted.

FIG. 9 illustrates the method for generating the second normal vector in the case where the projection surface stands upright in the vertical direction and only one component of the first normal vector is converted.

FIG. 10 illustrates a method for generating the second normal vector in a case where the projection surface inclines with respect to the vertical direction and only one component of the first normal vector is converted.

FIG. 11 illustrates the method for generating the second normal vector in the case where the projection surface inclines with respect to the vertical direction and only one component of the first normal vector is converted.

FIG. 12 illustrates the method for generating the second normal vector in the case where the projection surface inclines with respect to the vertical direction and only one component of the first normal vector is converted.

FIG. 13 illustrates a method for generating the second normal vector in a case where the projection surface stands upright in the vertical direction and multiple components of the first normal vector are converted.

FIG. 14 illustrates the method for generating the second normal vector in the case where the projection surface stands upright in the vertical direction and multiple components of the first normal vector are converted.

FIG. 15 illustrates the method for generating the second normal vector in the case where the projection surface stands upright in the vertical direction and multiple components of the first normal vector are converted.

FIG. 16 illustrates the method for generating the second normal vector in the case where the projection surface stands upright in the vertical direction and multiple components of the first normal vector are converted.

FIG. 17 illustrates a method for generating the second normal vector in a case where the projection surface inclines with respect to the vertical direction and multiple components of the first normal vector are converted.

FIG. 18 illustrates the method for generating the second normal vector in the case where the projection surface inclines with respect to the vertical direction and multiple components of the first normal vector are converted.

FIG. 19 illustrates the method for generating the second normal vector in the case where the projection surface inclines with respect to the vertical direction and multiple components of the first normal vector are converted.

FIG. 20 illustrates the method for generating the second normal vector in the case where the projection surface inclines with respect to the vertical direction and multiple components of the first normal vector are converted.

FIG. 21 is a flowchart showing the operation of the projector.

### DESCRIPTION OF EMBODIMENTS

An embodiment for implementing the present disclosure will be described below with reference to the drawings. Note, however, that dimensions and scales of portions in the drawings are made different from actual ones as appropriate. Furthermore, the embodiment described below is a preferable specific example of the present disclosure, and various technically preferable restrictions are therefore imposed on the embodiment, but the scope of the present disclosure is not limited to the embodiment unless there is a description that the present disclosure is particularly limited to the embodiment in the following description.

### 1: First Embodiment

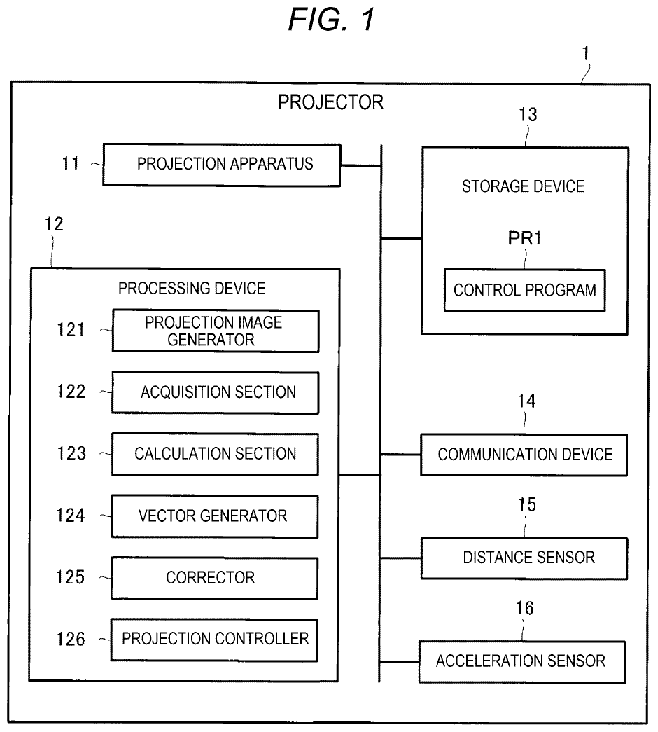

A projector 1 and a correction method according to a first embodiment will be described below with reference to FIGS. 1 to 21.

### 1-1: Configuration of First Embodiment

FIG. 1 is a functional block diagram showing an example of the configuration of the projector 1 according to the first embodiment. The projector 1 includes a projection apparatus 11, a processing device 12, a storage device 13, a communication device 14, a distance sensor 15, and an acceleration sensor 16. The elements of the projector 1 are connected to each other via a single bus or multiple buses for information communication. The elements of the projector 1 each include a single or multiple instruments. Some of the elements of the projector 1 may be omitted.

The projection apparatus 11 is an apparatus that projects an image generated by a projection image generator 121, which will be described later, on a screen S_{c}, a wall, or any other surface. The projection apparatus 11 projects various images under the control of the processing device 12. The projection apparatus 11 includes, for example, a light source, a liquid crystal panel, and a projection lens, modulates light from the light source through the liquid crystal panel, and projects the modulated light onto the screen S_{c}, the wall, or any other surface via the projection lens. The aspect in which the projection apparatus 11 includes a liquid crystal panel is merely an example, and aspects according to the present embodiment are not limited thereto. For example, the present embodiment is also applicable to a digital light processing (DLP: registered trademark) configuration including a digital mirror device (DMD) in place of a liquid crystal panel.

Note that the projection apparatus 11 is an example of an “optical apparatus”.

The processing device 12 is a processor that controls the entire projector 1, and is configured, for example, with a single chip or multiple chips. The processing device 12 is configured, for example, with a central processing unit (CPU) including an interface with a peripheral apparatus, an arithmetic device, a register, and so on. Note that some or all of the functions of the processing device 12 may be realized by hardware such as a digital signal processor (DSP), an application specific integrated circuit (ASIC), a programmable logic device (PLD), or a field programmable gate array (FPGA). The processing device 12 performs various types of processing in parallel or in sequence.

The storage device 13 is a recording medium readable by the processing device 12, and stores multiple programs including a control program PR1 to be executed by the processing device 12. The storage device 13 may be configured, for example, with at least one of a read only memory (ROM), an erasable programmable ROM (EPROM), an electrically erasable programmable ROM (EEPROM), and a random access memory (RAM). The storage device 13 may be called a register, a cache, a main memory, a main storage device, or the like.

The communication device 14 is hardware serving as a transmission and reception device for communicating with other apparatuses. Particularly in the present embodiment, the communication device 14 is a communication device that connects the projector 1 to the other apparatuses in a wired or wireless manner. The communication device 14 is also called, for example, a network device, a network controller, a network card, or a communication module.

The distance sensor 15 measures the distance between an object located around the projector 1 and the projector 1. In the present embodiment, the distance sensor 15 measures the distance from the projection apparatus 11 or the distance sensor 15 provided in the projector 1 to each of multiple points on a projection surface P_{P}. The distance sensor 15 is preferably a ToF (time-of-flight) sensor. The distance sensor 15 may instead, for example, be a light detection and ranging (LIDAR) device or a sonar that emits ultrasonic waves.

The acceleration sensor 16 is a sensor that detects acceleration acting on the projector 1. The acceleration sensor 16 is built in the projector 1 and fixed to a predetermined location in an enclosure of the projector 1. The predetermined location is, for example, a circuit board (not shown) on which the processing device 12 is mounted. The acceleration sensor 16 outputs a signal according to acceleration in the direction along each of an x-axis, a y-axis, and a z-axis, which will be described later, associated with a coordinate system of the projection apparatus 11. The acceleration sensor 16 is fixed to the predetermined location in the enclosure of the projector 1, so that the position of the acceleration sensor 16 in the enclosure is identified. That is, the relative positional relationship between the acceleration sensor 16 and the projection apparatus 11 is identified in advance. The acceleration sensor 16 is thus associated with the coordinate system of the projection apparatus 11.

The processing device 12 functions as a projection image generator 121, an acquisition section 122, a calculation section 123, a vector generator 124, a corrector 125, and a projection controller 126 by reading the control program PR1 from the storage device 13 and executing the control program PR1. Noe that the control program PR1 may be transmitted via a communication network that is not shown from another apparatus such as a server that manages the projector 1.

The projection image generator 121 generates a projection image P_{I} based on an input image acquired by the projection image generator 121. Note that the projection image generator 121 may acquire an input image from an apparatus external to the projector 1 or may acquire an input image stored in the storage device 13.

The acquisition section 122 acquires depth information indicating multiple distances from the distance sensor 15 to multiple positions on the projection surface P_{P} based on the output from the distance sensor 15.

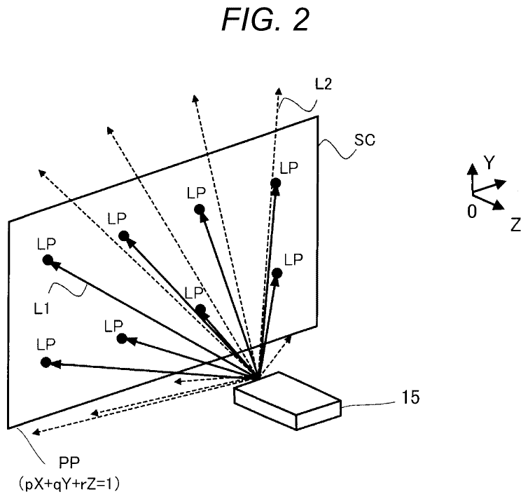

FIG. 2 shows an example of the depth information acquired by the acquisition section 122. It is assumed that the projector 1 and the projection surface P_{P} are set in an XYZ coordinate system, which is a world coordinate system, as shown in FIG. 2. It is further assumed that the projection surface P_{P} is substantially parallel to the XY plane, and that the optical axis of the projection lens of the projector 1 is substantially parallel to the Z-axis. Note that the term “substantially parallel” means being parallel with an error within an allowable range. The optical axis of the projection lens of the projector 1 is an example of an “optical axis”. As an example, when the distance sensor 15 is a ToF sensor, the distance sensor 15 irradiates multiple positions on the projection surface P_{P} with multiple laser beams L₁ and L₂. Out of the multiple laser beams L₁ and L₂, the multiple laser beams L₁ radiated onto the projection surface P_{P} form multiple light spots L_{P} on the projection surface P_{P}. On the other hand, the multiple laser beams L₂ are not directed to the projection surface P_{P} and do not form multiple light points L_{P} on the projection surface P_{P}. In FIG. 2, the multiple laser beams L₁ are drawn by using solid lines, and the multiple laser beams L₂ are drawn by using dotted lines. The distance sensor 15 outputs depth information indicating multiple distances from the distance sensor 15 to the multiple positions based on a period from the time at which the distance sensor 15 radiates the multiple laser beams L₁ to the time at which photodetectors provided in the distance sensor 15 detect reflected light from the multiple light spots L_{P} formed by the multiple laser beams L₁ on the projection surface P_{P}. The acquisition section 122 acquires the depth information output from the ToF sensor as the distance sensor 15.

Note that when the distance sensor 15 is a ToF sensor, the distance sensor 15 may irradiate the projection surface P_{P} with light from a surface emitting laser instead of irradiating the projection surface P_{P} with the multiple laser beams as described above. In this case, the multiple photodetectors (light receivers) discretely incorporated in the distance sensor 15 detect the reflected light from the projection surface P_{P}. The number of pixels (resolution) of the distance sensor 15 in the present embodiment is 4 px×4 px.

In FIG. 1, the calculation section 123 calculates the position of a plane based on the depth information acquired by the acquisition section 122. The plane may or may not be a plane that coincides with the projection surface P_{P}. Specifically, the plane means a plane the position of which in the XYZ coordinate system is calculated based on the depth information acquired by the acquisition section 122.

As an example, the calculation section 123 calculates the position of the plane in the order described below. Specifically, in the first stage, the calculation section 123 calculates, as the position of the plane, the equation of the plane pX+qY+rZ=1 in the XYZ coordinate system, which is the coordinate system of the distance sensor 15.

The calculation section 123 further calculates the normal vector for the plane described above at the second stage.

As an example, when the equation of the plane described above calculated by the calculation section 123 in the first stage is pX+qY+rZ=1, the calculation section 123 calculates the normal vector of the plane described above in the form of (X, Y, Z)=(p, q, r) in the second stage. Furthermore, in the third stage, the calculation section 123 converts the calculated normal vector into a vector in an xyz coordinate system, which will be described later and is a coordinate system of the projection lens provided in the projector 1, based on a correspondence that associates the XYZ coordinate system with the xyz coordinate system. The coordinate system of the projection lens is an example of “a coordinate system of the projector”. The “coordinate system of the projector” may instead be a coordinate system of a member provided in the projector 1 such as the panel. The correspondence that associates the XYZ coordinate system with the xyz coordinate system is identified, for example, by performing calibration relating to the positional relationship between the projection lens and the distance sensor 15, for example, at the time of manufacturing the projector 1. The normal vector for the plane described above in the xyz coordinate system is an example of a “first normal vector n”. Note that the calculation section 123 may calculate the equation of the plane in the coordinate system of the projection lens at the first stage. Similarly, the calculation section 123 may calculate the normal vector in the coordinate system of the projection lens at the second stage.

The calculation section 123 further calculates a gravity vector g in the xyz coordinate system based on the output from the acceleration sensor 16. The vector output by the acceleration sensor 16 is converted from a vector in the coordinate system of the acceleration sensor into a vector in the xyz coordinate system based on the correspondence. The correspondence that associates the coordinate system of the acceleration sensor with the xyz coordinate system is identified, for example, by performing calibration relating to the positional relationship between the projection lens and the acceleration sensor 16, for example, at the time of manufacturing the projector 1.

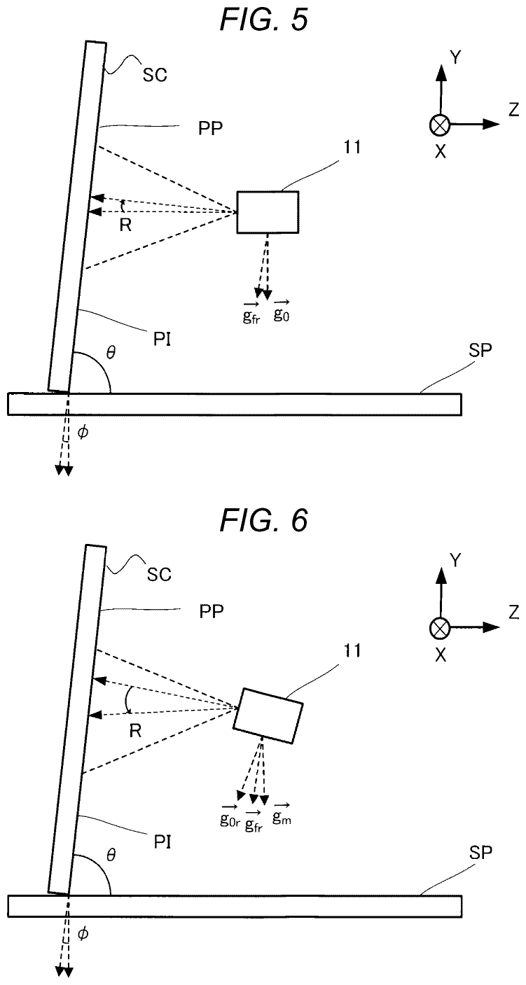

Note that examples of the first normal vector n and the gravity vector g described above will be described later with reference to FIGS. 5 to 18. The following description will be made on the assumption that the normal vector calculated based on the output from the distance sensor 15 and the vector output from the acceleration sensor 16 are both expressed in the same coordinate system or the xyz coordinate system.

The calculation section 123 further calculates an angle θ between an installation surface S_{P}, at which the projector 1 is installed, and the projection surface P_{P}. The installation surface S_{P} is, for example, a horizontal surface.

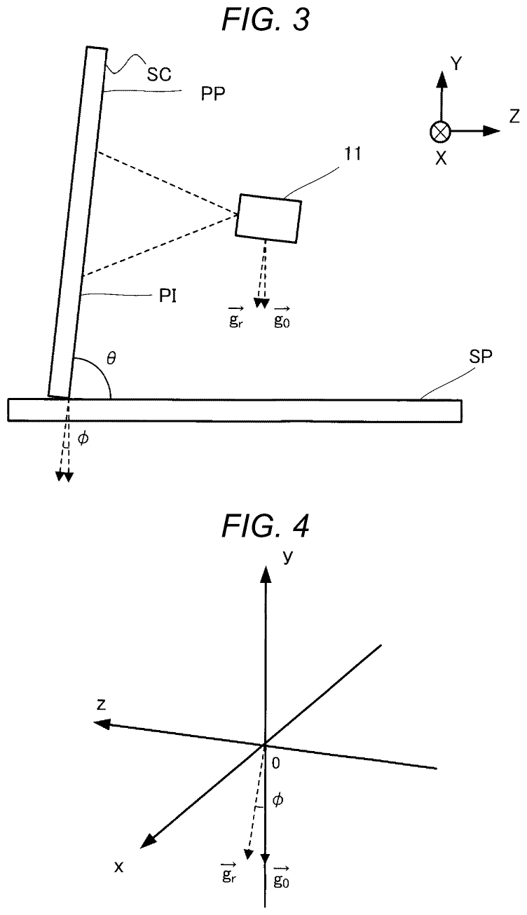

FIGS. 3 to 6 illustrate an example of a method for calculating the angle θ between the installation surface S_{P}, at which the projector 1 is installed, and the projection surface P_{P}.

A user of the projector 1 causes the projector 1 to project a rectangular projection image P_{I} onto the projection surface P_{P}, tilts the projector 1 as shown in FIG. 3 so that the projection image P_{I} becomes rectangular on the projection surface P_{P}, and adjusts the rolling angle of the projector 1. The “rolling angle” used herein is an angle between the installation surface S_{P} and the optical axis of the projector 1. Before the adjustment of the rolling angle, the calculation section 123 calculates an angle 9 between a gravity vector g₀ in the xyz coordinate system in the state in which the projector 1 is installed at the installation surface S_{P} and a gravity vector gᵣ in the xyz coordinate system after the adjustment of the rolling angle, as shown in FIG. 4. The calculation section 123 further calculates the angle θ between the installation surface S_{P}, at which the projector 1 is installed, and the projection surface P_{P} by subtracting the angle φ from 90°.

Instead, as shown in FIG. 5, the user of the projector 1 may cause the projector 1 including the horizontally set projection apparatus 11 to project a rectangular image onto the projection surface P_{P} and cause the projector 1 to perform electronic correction, instead of tilting the projector 1, in such a way that the image becomes rectangular on the projection surface P_{P}. In this case, the calculation section 123 converts the gravity vector g₀ calculated based on the output from the acceleration sensor 16 into a vector g_{fr} viewed from a point in front of the projection surface P_{P}, and calculates the angle between the gravity vector g₀ and the vector g_{fr} as the angle φ. Specifically, the calculation section 123 calculates the vector g_{fr} by multiplying the gravity vector g₀ calculated based on the output from the acceleration sensor 16 by a rotation matrix R representing the relationship between the posture of the projector 1 and the posture of the projection surface P_{P}. The calculation section 123 then calculates the angle between the gravity vector g₀ and the vector g_{fr} as the angle φ. The calculation section 123 further calculates the angle θ between the installation surface S_{P}, at which the projector 1 is installed, and the projection surface P_{P} by subtracting the angle φ from 90°.

Instead, when the projection surface P_{P} inclines with respect to the vertical direction and the projection apparatus 11 is installed obliquely with respect to the horizontal direction, the calculation section 123 converts a gravity vector gₘ calculated based on the output from the acceleration sensor 16 into the vector g_{fr} viewed from a point in front of the projection surface P_{P}, as shown in FIG. 6. The calculation section 123 then calculates, as the angle φ, the angle between the gravity vector g₀ calculated based on the output from the acceleration sensor 16 in the state in which the projection apparatus 11 is installed horizontally and the vector g_{fr}. Specifically, the calculation section 123 calculates the vector g_{fr} by multiplying the gravity vector gₘ calculated based on the output from the acceleration sensor 16 by the rotation matrix R representing the relationship between the posture of the projector 1 and the posture of the projection surface P_{P}. The calculation section 123 then calculates the angle between the gravity vector g₀ and the vector g_{fr} as the angle φ. The calculation section 123 further calculates the angle θ between the installation surface S_{P}, at which the projector 1 is installed, and the projection surface P_{P} by subtracting the angle φ from 90°.

Note that the state in which the projection image P_{I} used in the method for calculating the angle θ has a rectangular shape is merely an example. The projection image P_{I} may have any shape. In this case, the user of the projector 1 causes the projector 1 to project the projection image P_{I} having any shape onto the projection surface P_{P}, and adjusts the rolling angle of the projector 1 in such a way that the projection image P_{I} has a predetermined shape on the projection surface P_{P}. Instead, the user of the projector 1 causes the projector 1 to project the projection image P_{I} having any shape onto the projection surface P_{P}, and electronically corrects the projection image P_{I} in such a way that the projection image P_{I} has a predetermined shape on the projection surface P_{P}. Note that the “predetermined shape” used herein is a shape similar to the shape of the projection image P_{I} before projected.

In FIG. 1, the vector generator 124 converts the first normal vector n to generate a second normal vector n_{ng}.

A method for calculating the second normal vector n_{ng} by using the vector generator 124 will be described below in four separate cases.

A: A Case where the Projection Surface P_{P} Stands Upright in the Vertical Direction and Only One Component of the First Normal Vector n is Converted

FIGS. 7 to 9 illustrate a method for generating the second normal vector n_{ng} in a case where the projection surface P_{P} stands upright in the vertical direction and only one component of the first normal vector n is converted.

When the projection surface P_{P} stands upright in the vertical direction, the actual normal vector for the projection surface P_{P} and the gravity vector g are orthogonal to each other in the XYZ coordinate system, which is the world coordinate system. Therefore, also in the xyz coordinate system, which is the coordinate system of the projection lens, the actual normal vector for the projection surface P_{P} and the gravity vector gᵣ calculated based on the output from the acceleration sensor 16 are orthogonal to each other. As a result, let n=(aₙ, bₙ, cₙ) be the components of the first normal vector n calculated by the calculation section 123, and g=(a_{g}, b_{g}, c_{g}) be the components of the gravity vector g, and the value of aₙ·a_{g}+bₙ·b_{g}+cₙ·c_{g}, which is the inner product of the first normal vector n and the gravity vector g, should be intrinsically zero, as shown in FIG. 7. However, when the depth information used to calculate the first normal vector n contains an error in the measurement performed by the distance sensor 15 due to various factors, the inner product of the first normal vector n and the gravity vector g is not zero. In the present embodiment, the error in the measurement performed by the distance sensor 15 is caused by the multiple laser beams L₂ out of range of the projection surface P_{P} in FIG. 2. Since the multiple laser beams L₂ do not form the multiple light spots L_{P} on the projection surface P_{P}, the multiple laser beams L₂ are not reflected to the photodetectors provided in the distance sensor 15, and the number of pieces of distance data acquired by the photodetectors decreases by the number of the multiple laser beams L₂. The distance sensor 15 in the present embodiment can intrinsically acquire four sets of distance data along the Y axis, but cannot acquire two sets of distance data in FIG. 2. In this case, since the number of pieces of distance data acquired by the photodetectors decreases by the number of the multiple laser beams L₂, the calculation accuracy of the first normal vector n calculated based on the result of the detection performed by the distance sensor 15 decreases, so that the first normal vector n does not coincide with the actual normal vector for the projection surface P_{P}. Note that the error in the measurement is also produced due, for example, to an object having a color that is likely to absorb light and disposed between the projection surface P_{P} and the distance sensor 15.

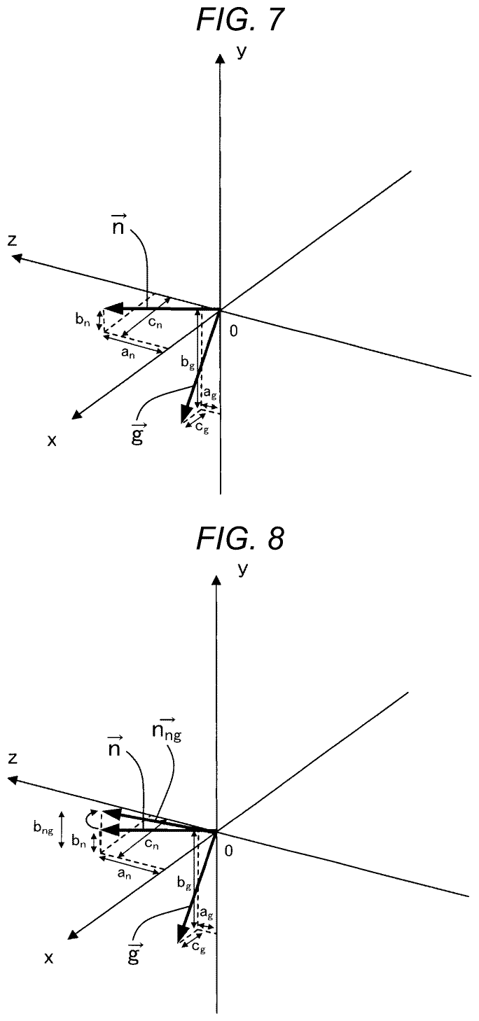

Under the circumstances described above, the vector generator 124 generates the second normal vector n_{ng}=(aₙ, b_{ng}, cₙ) as a result of conversion of only the y component of the first normal vector n by using Expression 1 below, as shown in FIG. 8.

$${b}_{n g} = - ( {a}_{n} \cdot {a}_{g} + {c}_{n} \cdot {c}_{g} ) / {b}_{g} \qquad [ Expression 1 ]$$

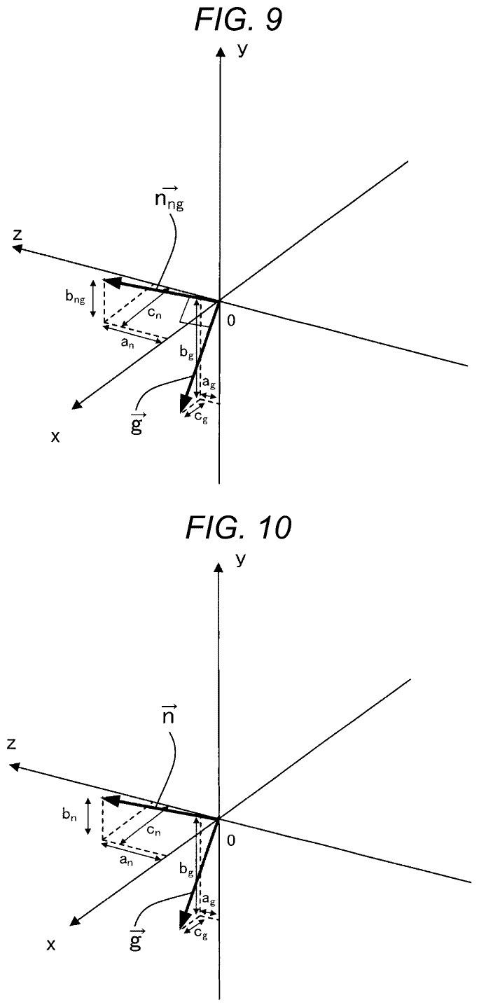

As a result, the inner product of the second normal vector n_{ng} and the gravity vector g is zero, as shown in FIG. 9. In other words, the second normal vector n_{ng} and the gravity vector g are orthogonal to each other. Since the second normal vector n_{ng} is orthogonal to the gravity vector g, the second normal vector n_{ng} is more approximate to the actual normal vector for the projection surface P_{P} than the first normal vector n.

As described above, when the second normal vector n_{ng}=(aₙ, b_{ng}, cₙ) is not generated by converting the y component of the first normal vector n=(aₙ, bₙ, cₙ), but the second normal vector n_{ng}=(a_{ng}, bₙ, cₙ) is generated by converting the x component of the first normal vector n=(aₙ, bₙ, cₙ), the vector generator 124 converts the x component an of the first normal vector n into the x component a_{ng} of the second normal vector n_{ng} by using Expression 2 below.

$${a}_{n g} = - ( {b}_{n} \cdot {b}_{g} + {c}_{n} \cdot cg ) / {a}_{g} \qquad [ Expression 2 ]$$

As described above, the vector generator 124 generates the second normal vector n_{ng} based on the first normal vector n and the gravity vector g. Even when the x or y component of the three components that constitute the first normal vector n is unknown, the vector generator 124 can generate the second normal vector n_{ng}, as indicated by Expressions 1 and 2 described above. The vector generator 124 can therefore generate the second normal vector n_{ng} as long as the acquisition section 122 can acquire depth information at at least two points on the projection surface P_{P}.

B: A Case where the Projection Surface P_{P} Inclines with Respect to the Vertical Direction and Only One Component of the First Normal Vector n is Converted

FIGS. 10 to 12 illustrate a method for generating the second normal vector n_{ng} in a case where the projection surface P_{P} inclines with respect to the vertical direction and only one component of the first normal vector n is converted.

When the installation surface S_{P}, at which the projector 1 is installed, is a horizontal surface, the projection surface P_{P} inclines with respect to the vertical direction, and the angle between the installation surface S_{P} and the projection surface P_{P} is the angle θ, the actual normal vector for the projection surface P_{P} and the gravity vector g form the angle θ in the XYZ coordinate system, which is the world coordinate system. Therefore, also in the xyz coordinate system, which is the panel coordinate system, the actual normal vector for the projection surface P_{P} and the gravity vector gᵣ calculated based on the output from the acceleration sensor 16 form the angle θ. As a result, under the definition of n=(aₙ, bₙ, cₙ) being the components of the first normal vector n calculated by the calculation section 123, and g=(a_{g}, b_{g}, c_{g}) being the components of the gravity vector g, and when the two vectors are normalized, the value of aₙ·a_{g}+bₙ·b_{g}+cₙ·c_{g}, which is the inner product of the first normal vector n and the gravity vector g, should be intrinsically cos(θ), as shown in FIG. 10. However, when the depth information used to calculate the first normal vector n contains an error produced by the distance sensor 15, the inner product of the first normal vector n and the gravity vector g is not cos(θ). In this case, the first normal vector n calculated based on the result of the detection performed by the distance sensor 15 does not coincide with the actual normal vector for the projection surface P_{P}.

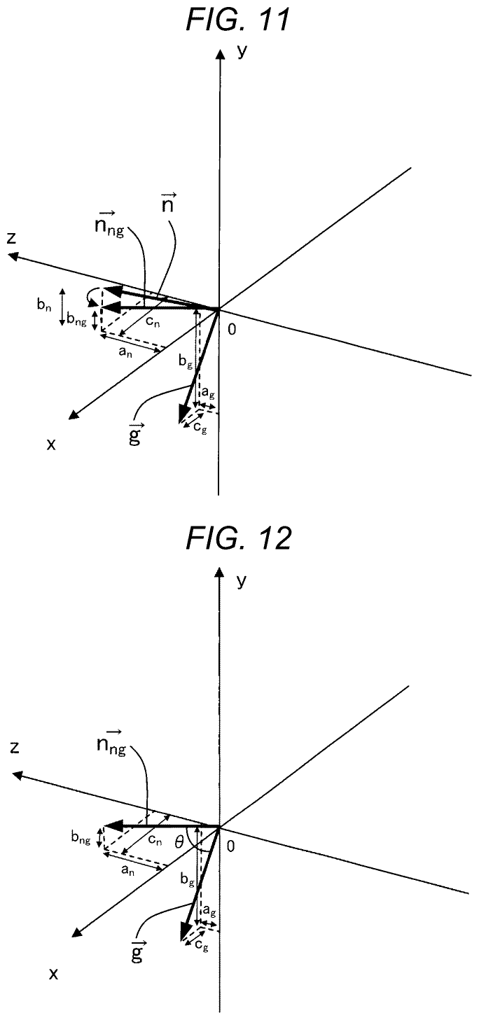

Under the circumstances described above, the vector generator 124 generates the second normal vector n_{ng}=(aₙ, b_{ng}, cₙ) as a result of conversion of only the y component of the first normal vector n by using Expression 3 below, as shown in FIG. 11.

$${b}_{n g} = - \{ cos ( θ ) - ( {a}_{n} \cdot {a}_{g} + {c}_{n} \cdot {c}_{g} ) \} / {b}_{g} \qquad [ Expression 3 ]$$

As a result, the inner product of the second normal vector n_{ng} and the gravity vector g is cos(θ), as shown in FIG. 12. In other words, the second normal vector n_{ng} and the gravity vector g form the angle θ. Since the second normal vector n_{ng} and the gravity vector g form the angle θ, the second normal vector n_{ng} is more approximate to the actual normal vector for the projection surface P_{P} than the first normal vector n.

Unlike the above description, when the second normal vector n_{ng}=(aₙ, b_{ng}, cₙ) is not calculated by converting the y component of the first normal vector n=(aₙ, bₙ, cₙ), but the second normal vector n_{ng}=(a_{ng}, bₙ, cₙ) is generated by converting the x component of the first normal vector n=(aₙ, bₙ, cₙ), the vector generator 124 converts the x component aₙ of the first normal vector n into the x component a_{ng} of the second normal vector n_{ng} by using Expression 4 below.

$${a}_{n g} = \{ cos ( θ ) - ( {b}_{n} \cdot {b}_{g} + {c}_{n} \cdot {c}_{g} ) \} / {a}_{g} \qquad [ Expression 4 ]$$

Note that when the floor or the ceiling is the projection surface P_{P} and the floor or the ceiling is set horizontal, the inner product of the normal vector for the projection surface P_{P} and the gravity vector g is intrinsically one. When the floor or the ceiling is the projection surface P_{P} and the floor or the ceiling is set oblique, the inner product of the normal vector for the projection surface P_{P} and the gravity vector is intrinsically cos(θ). Therefore, also when the floor or the ceiling is used as the projection surface P_{P}, the vector generator 124 generates the second normal vector n_{ng} by using the same method described above.

As described above, the vector generator 124 generates the second normal vector n_{ng} based on the first normal vector n and the gravity vector g. Even when the x or y component of the three components that constitute the first normal vector n is unknown, the vector generator 124 can generate the second normal vector n_{ng}, as indicated by Expressions 3 and 4 described above. The vector generator 124 can therefore generate the second normal vector n_{ng} as long as the acquisition section 122 can acquire depth information at at least two points on the projection surface P_{P}.

C: A Case where the Projection Surface P_{P} Stands Upright in the Vertical Direction and Multiple Components of the First Normal Vector n are Converted

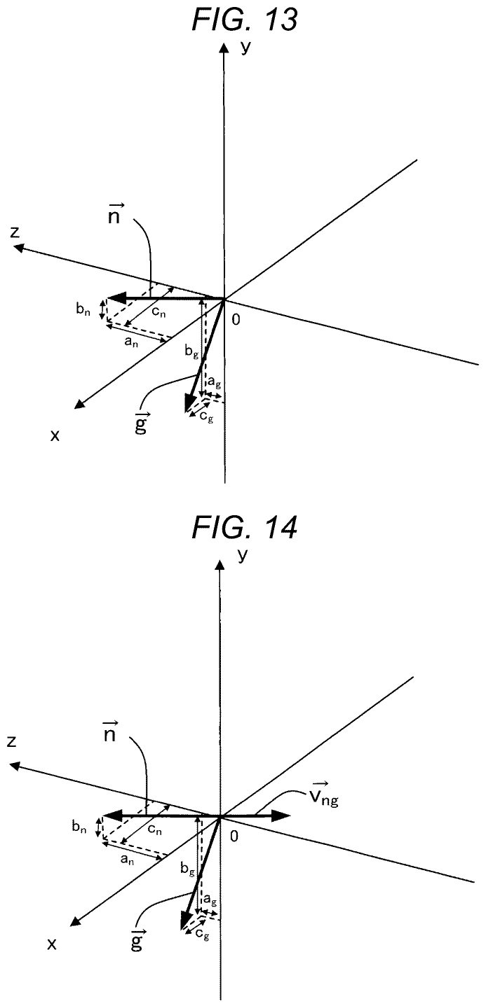

FIGS. 13 to 16 illustrate a method for generating the second normal vector n_{ng} in a case where the projection surface P_{P} stands upright in the vertical direction and multiple components of the first normal vector n are converted.

Note that the generation method uses the fact that the actual normal vector for the projection surface P_{P} and the gravity vector g are orthogonal to each other, as the calculation method in A described above.

It is assumed as shown in FIG. 13 that the components of the first normal vector n calculated by the calculation section 123 are n=(aₙ, bₙ, cₙ), and that the components of the gravity vector g are g=(a_{g}, b_{g}, c_{g}). The vector generator 124 generates an orthogonal vector v_{ng} orthogonal to both the first normal vector n and the gravity vector g by calculating the outer product of the first normal vector n and the gravity vector g, as shown in FIG. 14.

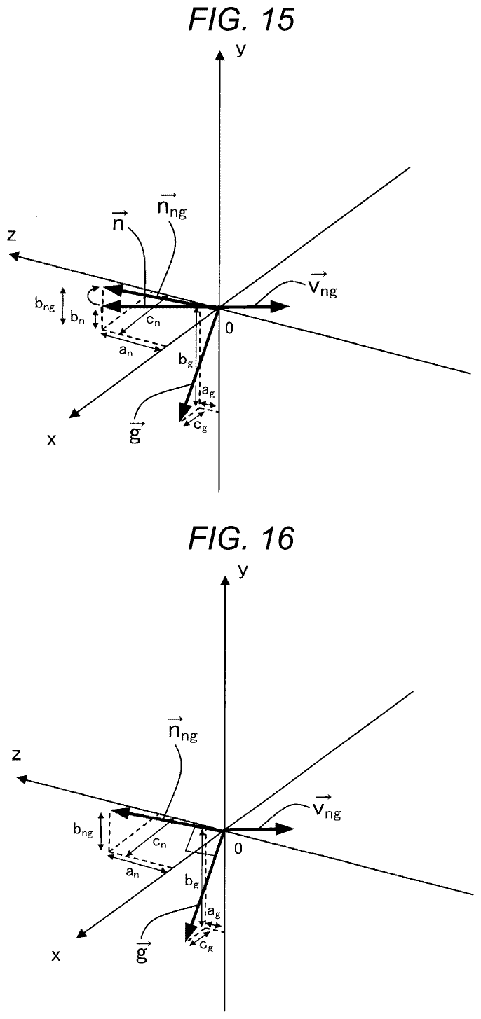

The vector generator 124 then generates the second normal vector n_{ng} orthogonal to both the orthogonal vector v_{ng} and the gravity vector g by calculating the outer product of the orthogonal vector v_{ng} and the gravity vector g, as shown in FIG. 15. In other words, the vector generator 124 generates the second normal vector n_{ng} by rotating the gravity vector g around the orthogonal vector v_{ng} as an axis of rotation in such a way that the rotated gravity vector g is orthogonal to the original gravity vector g.

The second normal vector n_{ng} is orthogonal to the gravity vector g as in the calculation method in A described above, as shown in FIG. 16. Since the second normal vector n_{ng} is orthogonal to the gravity vector g, the second normal vector n_{ng} is more approximate to the actual normal vector for the projection surface P_{P} than the first normal vector n.

As described above, the vector generator 124 generates the second normal vector n_{ng} based on the outer product of the orthogonal vector v_{ng} and the gravity vector g. The orthogonal vector v_{ng} is a vector that couples two points to each other on the projection surface P_{P}. The vector generator 124 can therefore generate the second normal vector n_{ng} as long as the acquisition section 122 can acquire depth information at at least two points on the projection surface P_{P}.

D: A Case where the Projection Surface P_{P} Inclines with Respect to the Vertical Direction and Multiple Components of the First Normal Vector n are Converted

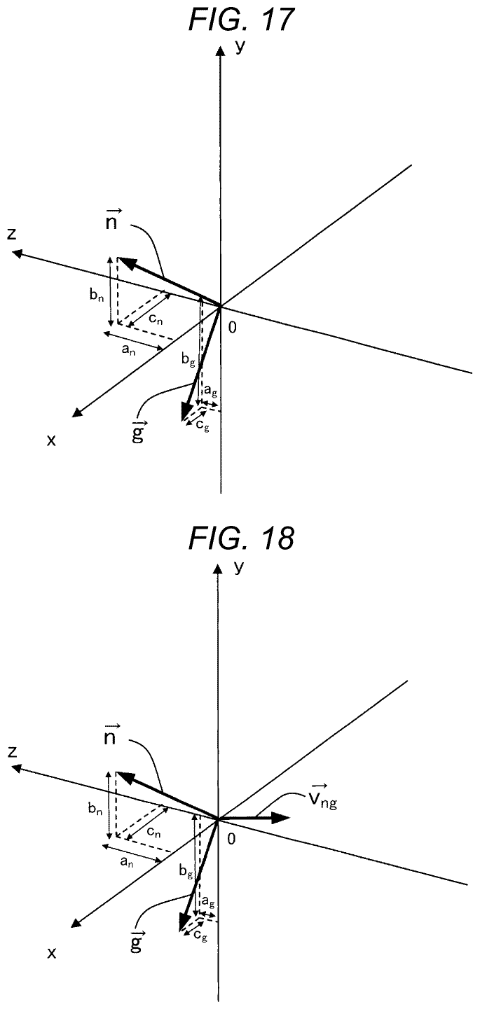

FIGS. 17 to 20 illustrate a method for generating the second normal vector n_{ng} in a case where the projection surface P_{P} inclines with respect to the vertical direction and multiple components of the first normal vector n are converted.

Note that the generation method uses the fact that the actual normal vector for the projection surface P_{P} and the gravity vector g form the angle θ, as the generation method in B described above.

It is assumed as shown in FIG. 17 that the components of the first normal vector n calculated by the calculation section 123 are n=(aₙ, bₙ, cₙ), and that the components of the gravity vector g are g=(a_{g}, b_{g}, c_{g}). The vector generator 124 generates the orthogonal vector v_{ng} orthogonal to both the first normal vector n and the gravity vector g by calculating the outer product of the first normal vector n and the gravity vector g, as shown in FIG. 18.

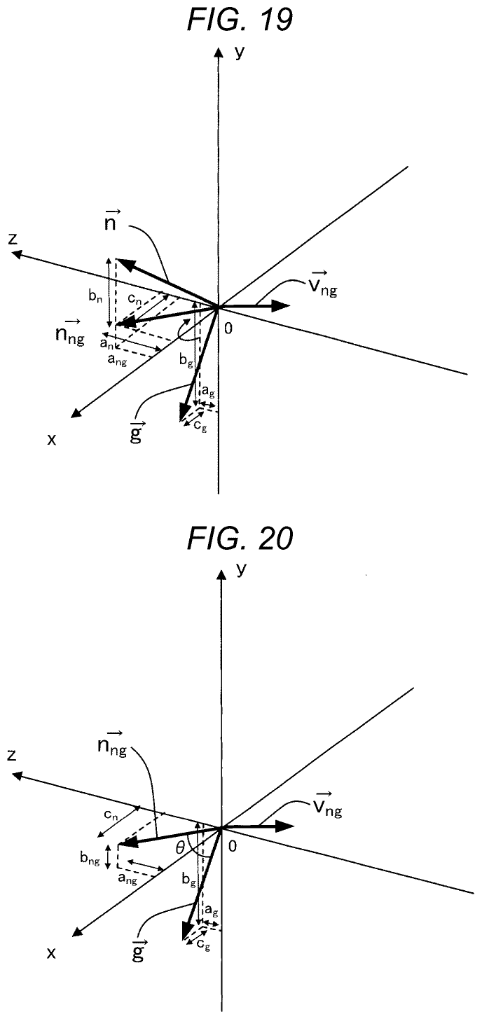

The vector generator 124 then generates the second normal vector n_{ng} by rotating the gravity vector g around the orthogonal vector v_{ng} as an axis of rotation in such a way that the angle between the rotated gravity vector g and the original gravity vector g is the angle θ, as shown in FIG. 19.

The second normal vector n_{ng} and the gravity vector g form the angle θ as in the generation method in B described above, as shown in FIG. 20. Since the second normal vector n_{ng} and the gravity vector g form the angle θ, the second normal vector n_{ng} is more approximate to the actual normal vector for the projection surface P_{P} than the first normal vector n.

As described above, the vector generator 124 generates the second normal vector n_{ng} based on the outer product of the orthogonal vector v_{ng} and the gravity vector g. The orthogonal vector v_{ng} is a vector that couples two points to each other on the projection surface P_{P}. The vector generator 124 can therefore generate the second normal vector n_{ng} as long as the acquisition section 122 can acquire depth information at at least two points on the projection surface P_{P}.

The vector generator 124 generates the second normal vector n_{ng} in each of the cases A to D described above. In A and B out of all the cases, the vector generator 124 generates the second normal vector n_{ng} by converting only the x or y component of the three components of the first normal vector n=(aₙ, bₙ, cₙ).

In the xyz coordinate system, when the z-axis is the optical axis of the projector 1 and the angle between the x-axis and the vertical direction is smaller than the angle between the y-axis and the vertical direction, it is preferable that the vector generator 124 generates the second normal vector n_{ng} by converting only the x component of the three components of the first normal vector n. When the z-axis is the optical axis of the projector 1 and the angle between the y-axis and the vertical direction is smaller than the angle between the x-axis and the vertical direction, it is preferable that the vector generator 124 generates the second normal vector n_{ng} by converting only the y component of the three components of the first normal vector n.

In FIG. 1, the corrector 125 uses the second normal vector n_{ng} generated by the vector generator 124 to correct the projection image P_{I} generated by the projection image generator 121.

As an example, the corrector 125 uses the second normal vector n_{ng} to perform trapezoidal correction on the projection image P_{I} on the projection surface P_{P} so that the projection image P_{I} has a rectangular shape.

The projection controller 126 causes the projection apparatus 11 to project the projection image P_{I} corrected by the corrector 125 onto the projection surface P_{P}.

### 1-2: Operation in First Embodiment

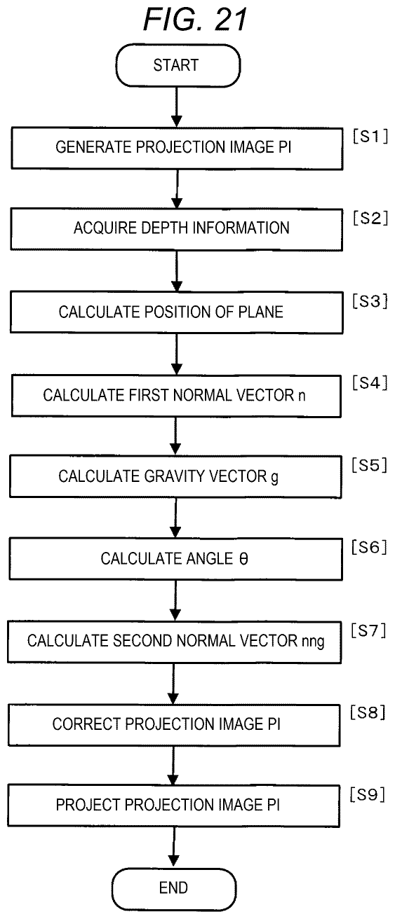

FIG. 21 is a flowchart showing the operation of the projector 1 according to the present embodiment.

In step S1, the processing device 12 functions as the projection image generator 121. The processing device 12 generates the projection image P_{I} based on an input image.

In step S2, the processing device 12 functions as the acquisition section 122. The processing device 12 acquires depth information indicating multiple distances from the distance sensor 15 to multiple positions on the projection surface P_{P} based on the output from the distance sensor 15.

In step S3, the processing device 12 functions as the calculation section 123. The processing device 12 calculates the position of the plane based on the depth information acquired in step S2.

In step S4, the processing device 12 functions as the calculation section 123. The processing device 12 calculates the first normal vector n, which is the normal vector for the plane the position of which has been calculated in step S3.

In step S5, the processing device 12 functions as the calculation section 123. The processing device 12 calculates the gravity vector g based on the output from the acceleration sensor 16.

In step S6, the processing device 12 functions as the calculation section 123. The processing device 12 calculates the angle θ between the installation surface S_{P}, at which the projector 1 is installed, and the projection surface P_{P}. The installation surface S_{P} is, for example, a horizontal surface.

In step S7, the processing device 12 functions as the vector generator 124. The processing device 12 calculates the second normal vector n_{ng}, which is the normal vector for the projection surface P_{P}.

In step S8, the processing device 12 functions as the corrector 125. The processing device 12 uses the second normal vector n_{ng} generated in step S7 to correct the projection image P_{I} generated in step S1.

In step S9, the processing device 12 functions as the projection controller 126. The processing device 12 causes the projection apparatus 11 to project the projection image P_{I} corrected in step S8 onto the projection surface P_{P}.

### 2: Variations

The embodiment described above can be changed in various manners. Specific aspects of the variations will be presented below by way of example. The aspects presented below by way of example and the aspects shown in the embodiment described above can be combined with each other as appropriate to the extent that the aspects to be combined with each other do not contradict each other. Note that in the variations presented below by way of example, elements providing effects and having functions that are the same as those in the embodiment have the same reference characters referred to in the above description, and will not be described in detail as appropriate.

### 2-1: Variation 1

The acquisition section 122 may acquire the aspect ratio of the projection image P_{I}. In this case, it is preferable that the vector generator 124 generates the second normal vector n_{ng} by converting, based on the aspect ratio acquired by the acquisition section 122, any of the components in the directions of the x-axis and the y-axis orthogonal to the z-axis, which is the optical axis, and orthogonal to each other out of the components that constitute the first normal vector n in the xyz coordinate system.

For example, when the length of the projection image P_{I} in the x-axis direction is longer than the length thereof in the y-axis direction, it is preferable that the vector generator 124 generates the second normal vector n_{ng} by converting the y component of the components that constitute the first normal vector n. When the length of the projection image P_{I} in the y-axis direction is longer than the length thereof in the x-axis direction, it is preferable that the vector generator 124 generates the second normal vector n_{ng} by converting the x component of the components that constitute the first normal vector n.

### 2-2: Variation 2

The acquisition section 122 may instead acquire a captured image of the projection surface P_{P} imaged by a camera that is not shown but differs from the distance sensor 15. The calculation section 123 then generates a converted image as a result of conversion of the captured image of the projection surface P_{P} into an image in the coordinate system of the distance sensor 15 based on a correspondence that associates the coordinate system of the distance sensor 15 with the coordinate system of the camera. The correspondence is expressed, for example, in the form of a matrix that associates the pixels of the distance sensor 15 with the pixels of the imager of the camera. The correspondence is identified by performing calibration relating to the positional relationship between the distance sensor 15 and the camera in advance, for example, at the time of manufacturing the projector 1. The calculation section 123 further generates position information that is information indicating the position of the projection surface P_{P} in the detection range of the distance sensor 15 based on the converted image. In this case, it is preferable that the vector generator 124 generates the second normal vector n_{ng} by converting, based on the position information generated by the calculation section 123, any of the components in the directions of the x-axis and the y-axis orthogonal to the z-axis, which is the optical axis, and orthogonal to each other out of the components that constitute the first normal vector n in the xyz coordinate system. Note that the camera may be built in the projection apparatus 11 or may be an external device coupled to the projection apparatus 11.

For example, when a horizontally elongated screen S_{c} having a length in the X-axis direction longer than the length in the Y-axis direction is used, it is preferable that the vector generator 124 generates the second normal vector n_{ng} by converting the y component of the components that constitute the first normal vector n. This is because, when the horizontally elongated screen S_{c} is used, the multiple laser beams L₂ are likely to be generated, and a sufficient number of pieces of distance data for identifying the y component of the first normal vector n cannot be obtained, so that the calculation accuracy of the y component of the first normal vector n decreases, as shown in FIG. 2. Therefore, when the horizontally elongated screen S_{c} is used, a highly accurate second normal vector n_{ng} can be generated by converting the y component the accuracy of which is relatively likely to decrease. When a horizontally elongated screen S_{c} having a length in the Y-axis direction longer than the length in the X-axis direction is used, it is preferable that the vector generator 124 generates the second normal vector n_{ng} by converting the x component of the components that constitute the first normal vector n.

### 3: Summary of Present Disclosure

The present disclosure will be summarized below as additional remarks.

Additional Remark 1 A method for correcting a projection image projected from a projector onto a projection surface, the method including: acquiring depth information indicating multiple distances from a distance sensor to multiple positions on the projection surface based on an output from the distance sensor; calculating a position of a plane based on the depth information; calculating a first normal vector for the plane; calculating a gravity vector based on an output from an acceleration sensor associated with a coordinate system of the projector; generating a second normal vector by converting the first normal vector in such a way that an inner product of the gravity vector and the first normal vector is a cosine of an angle between a horizontal plane and the projection surface; and correcting the projection image based on the second normal vector.

Since the correction method according to the present embodiment is configured as described above, the accuracy of the correction of the projection image P_{I} does not depend on the accuracy of the distance sensor 15, so that the accuracy of the correction can be increased. Specifically, the projector 1 can use the correction method described above to perform trapezoidal correction on the projection image P_{I} based on the second normal vector n_{ng} generated by converting the first normal vector n. The second normal vector n_{ng} is more approximate to the actual normal vector for the projection surface P_{P} than the first normal vector n. As a result, the projector 1 can increase the accuracy of the correction of the projection image P_{I}.

In the related art, it is necessary to acquire depth information at at least three points to generate the normal vector for the projection surface P_{P}. In the correction method according to the present embodiment, however, the second normal vector n_{ng} can be generated only by acquiring depth information at at least two points, as described above. Even a combination of the distance sensor 15 only capable of acquiring two-dimensional distance information, such as 2D-LiDAR, and the acceleration sensor 16 therefore allows highly accurate trapezoidal correction.

Additional Remark 2 A method for correcting a projection image projected from a projector onto a projection surface, the method including: acquiring depth information indicating multiple distances from a distance sensor to multiple positions on the projection surface based on an output from the distance sensor; calculating a position of a plane based on the depth information; calculating a first normal vector for the plane; calculating a gravity vector based on an output from an acceleration sensor associated with a coordinate system of the projector; calculating an outer product of the gravity vector and the first normal vector to generate an orthogonal vector orthogonal to both the gravity vector and the first normal vector; generating, as a second normal vector that is a normal vector for the projection surface, a rotation vector as a result of rotation of the gravity vector around an axis along the orthogonal vector by an angle between a horizontal plane and the projection surface; and correcting the projection image based on the second normal vector.

Since the correction method according to the present embodiment is configured as described above, the accuracy of the correction of the projection image P_{I} does not depend on the accuracy of the distance sensor 15, so that the accuracy of the correction can be increased. Specifically, the projector 1 can use the correction method described above to perform trapezoidal correction on the projection image P_{I} based on the second normal vector n_{ng} generated by converting the first normal vector n. The second normal vector n_{ng} is more approximate to the actual normal vector for the projection surface P_{P} than the first normal vector n. As a result, the projector 1 can increase the accuracy of the correction of the projection image P_{I}.

In the related art, it is necessary to acquire depth information at at least three points to generate the normal vector for the projection surface P_{P}. In the correction method according to the present embodiment, however, the second normal vector n_{ng} can be generated only by acquiring depth information at at least two points, as described above. Even a combination of the distance sensor 15 only capable of acquiring two-dimensional distance information, such as 2D-LiDAR, and the acceleration sensor 16 therefore allows highly accurate trapezoidal correction.

Additional Remark 3 A method for correcting a projection image projected from a projector onto a projection surface, the method including: acquiring depth information indicating multiple distances from a distance sensor to multiple positions on the projection surface based on an output from the distance sensor; calculating a position of a plane based on the depth information; calculating a first normal vector for the plane; calculating a gravity vector based on an output from an acceleration sensor associated with a coordinate system of the projector; calculating an outer product of the gravity vector and the first normal vector to generate an orthogonal vector orthogonal to both the gravity vector and the first normal vector; calculating an outer product of the orthogonal vector and the gravity vector to generate a second normal vector orthogonal to both the orthogonal vector and the gravity vector; and correcting the projection image based on the second normal vector.

Since the correction method according to the present embodiment is configured as described above, the accuracy of the correction of the projection image P_{I} does not depend on the accuracy of the distance sensor 15, so that the accuracy of the correction can be increased. Specifically, the projector 1 can use the correction method described above to perform trapezoidal correction on the projection image P_{I} based on the second normal vector n_{ng} generated by converting the first normal vector n. The second normal vector n_{ng} is more approximate to the actual normal vector for the projection surface P_{P} than the first normal vector n. As a result, the projector 1 can increase the accuracy of the correction of the projection image P_{I}.

In the related art, it is necessary to acquire depth information at at least three points to generate the normal vector for the projection surface P_{P}. In the correction method according to the present embodiment, however, the second normal vector n_{ng} can be generated only by acquiring depth information at at least two points, as described above. Even a combination of the distance sensor 15 only capable of acquiring two-dimensional distance information, such as 2D-LiDAR, and the acceleration sensor 16 therefore allows highly accurate trapezoidal correction.

Additional Remark 4 The correction method according to Additional Remark 1, further including: acquiring a captured image of the projection surface by capturing an image of the projection surface with a camera different from the distance sensor; generating a converted image as a result of conversion of the captured image into an image in a coordinate system of the distance sensor based on a correspondence that associates the coordinate system of the distance sensor with a coordinate system of the camera; and generating information indicating a position of the projection surface in a detection range of the distance sensor based on the converted image, wherein generating the second normal vector includes generating the second normal vector by converting any of components in directions of two axes orthogonal to an optical axis of the projector and orthogonal to each other out of components that constitute the first normal vector in the coordinate system of the projector based on the information.

The correction method according to the present embodiment, which is configured as described above, can correct only a component that is expected to fail to have sufficient accuracy out of the x and y components of the first normal vector n.

Additional Remark 5 The correction method according to Additional Remark 1, wherein generating the second normal vector includes generating the second normal vector by converting a component on an axis inclining by a smaller angle with respect to a vertical direction out of two axes orthogonal to an optical axis of the projector and orthogonal to each other out of components that constitute the first normal vector in the coordinate system of the projector.

When the component in a direction close to the vertical direction is not expected to have sufficient accuracy, the correction method according to the present embodiment, which is configured as described above, can correct only the component.

Additional Remark 6 The correction method according to Additional Remark 1 or 2, further including calculating, when an angle between an installation surface of the projector and an optical axis of the projector is so adjusted that a shape of the projection image on the projection surface becomes a predetermined shape, an angle between the horizontal plane and the projection surface based on an angle between the gravity vector before the adjustment and the gravity vector after the adjustment.

The correction method according to the present embodiment, which is configured as described above, can calculate the angle between the horizontal plane and the projection surface P_{P} based on the output from the acceleration sensor 16.

What is claimed is:

1. A method for correcting a projection image projected from a projector onto a projection surface, the method comprising:
acquiring depth information indicating multiple distances from a distance sensor to multiple positions on the projection surface based on an output from the distance sensor;
calculating a position of a plane based on the depth information;
calculating a first normal vector for the plane;
calculating a gravity vector based on an output from an acceleration sensor associated with a coordinate system of the projector;
generating a second normal vector by converting the first normal vector in such a way that an inner product of the gravity vector and the first normal vector is a cosine of an angle between a horizontal plane and the projection surface; and
correcting the projection image based on the second normal vector.

2. A method for correcting a projection image projected from a projector onto a projection surface, the method comprising:
acquiring depth information indicating multiple distances from a distance sensor to multiple positions on the projection surface based on an output from the distance sensor;
calculating a position of a plane based on the depth information;
calculating a first normal vector for the plane;
calculating a gravity vector based on an output from an acceleration sensor associated with a coordinate system of the projector;
calculating an outer product of the gravity vector and the first normal vector to generate an orthogonal vector orthogonal to both the gravity vector and the first normal vector;
generating, as a second normal vector that is a normal vector for the projection surface, a rotation vector as a result of rotation of the gravity vector around an axis along the orthogonal vector by an angle between a horizontal plane and the projection surface; and
correcting the projection image based on the second normal vector.

3. A method for correcting a projection image projected from a projector onto a projection surface, the method comprising:
acquiring depth information indicating multiple distances from a distance sensor to multiple positions on the projection surface based on an output from the distance sensor;
calculating a position of a plane based on the depth information;
calculating a first normal vector for the plane;
calculating a gravity vector based on an output from an acceleration sensor associated with a coordinate system of the projector;
calculating an outer product of the gravity vector and the first normal vector to generate an orthogonal vector orthogonal to both the gravity vector and the first normal vector;
calculating an outer product of the orthogonal vector and the gravity vector to generate a second normal vector orthogonal to both the orthogonal vector and the gravity vector; and
correcting the projection image based on the second normal vector.

4. The correction method according to claim 1, further comprising:
acquiring a captured image of the projection surface by capturing an image of the projection surface with a camera different from the distance sensor;
generating a converted image as a result of conversion of the captured image into an image in a coordinate system of the distance sensor based on a correspondence that associates the coordinate system of the distance sensor with a coordinate system of the camera; and
generating information indicating a position of the projection surface in a detection range of the distance sensor based on the converted image,
wherein generating the second normal vector includes generating the second normal vector by converting any of components in directions of two axes orthogonal to an optical axis and orthogonal to each other out of components that constitute the first normal vector in the coordinate system of the projector based on the information.

5. The correction method according to claim 1, wherein
generating the second normal vector includes generating the second normal vector by converting a component on an axis inclining by a smaller angle with respect to a vertical direction out of two axes orthogonal to an optical axis and orthogonal to each other out of components that constitute the first normal vector in the coordinate system of the projector.

6. The correction method according to claim 1, further comprising
calculating, when an angle between an installation surface and an optical axis of the projector is so adjusted that a shape of the projection image on the projection surface becomes a predetermined shape, an angle between the horizontal plane and the projection surface based on an angle between the gravity vector before the adjustment and the gravity vector after the adjustment.
